(19) United States
(12) Patent Application Publication
(10) Pub. No.: US 2026/0063088 A1
(43) Pub. Date: Mar. 5, 2026

(54) METHOD AND APPARATUS FOR CONTROLLING AN ENGINE OF A VEHICLE

(71) Applicants: HYUNDAI MOTOR COMPANY, Seoul (KR); Kia Corporation, Seoul (KR)

(72) Inventors: Juhyun KIM, Hwaseong-si (KR); Jae Yeon LEE, Hwaseong-si (KR); Seung Jun LEE, Hwaseong-si (KR)

(21) Appl. No.: 19/319,206

(22) Filed: Sep. 4, 2025

(30) Foreign Application Priority Data
Sep. 4, 2024 (KR) 10-2024-0120356

(51) Int. Cl. F02D 41/24; F02D 41/06; F02D 41/14; F02D 41/40

(52) U.S. Cl. CPC F02D 41/2458; F02D 41/061; F02D 41/1452; F02D 41/40; F02D 2041/143; F02D 2041/1433

(57) ABSTRACT

A method for controlling an engine of a vehicle by a controller includes determining whether a running time of the engine exceeds a reference driving time, based on the running time being less than or equal to the reference driving time, determining a first CO2 emission amount corresponding to the driving time by utilizing an MAF sensor, determining a model CO2 amount based on a first regression model that has correlation data between a combusted fuel amount and a CO2 emission amount of the engine, comparing the first CO2 emission amount with the model CO2 amount, determining a correction factor to adjust the first regression model based on comparing the first CO2 emission amount with the model CO2 amount, determining a second CO2 emission amount through a second regression model generated by applying the correction factor, and controlling the engine based on the second CO2 emission amount.

### CROSS-REFERENCE TO RELATED APPLICATION

This application claims priority to and the benefit of Korean Patent Application No. 10-2024-0120356, filed with the Korean Intellectual Property Office, on Sep. 4, 2024, the entire contents of which are incorporated herein by reference.

### TECHNICAL FIELD

The present disclosure relates to a method and apparatus for controlling an engine of a vehicle, and more particularly, the present disclosure relates to a method and apparatus for controlling an engine of a vehicle capable of deriving an accurate CO₂ emission amount without additionally employing an CO₂ sensor to utilize it for calculating an engine work amount and control the engine.

### BACKGROUND

In order to respond to global exhaust gas regulations, vehicles can calculate the driving work amount of a vehicle engine (hereinafter referred to as “engine work amount”).

For example, some techniques calculate the engine work by using an engine speed (e.g., revolution per minute (RPM)) and a fuel amount (or torque) of vehicle driving information. In line with recent trends in CO₂ reduction regulations for internal combustion engines, on-board monitoring (OBM) and Euro 7 regulations, discussions are ongoing on changing of the regulations to calculate the engine work from CO₂ emissions. Therefore, manufacturers are continuing to research ways to proactively respond to these changes in EU legislation.

CO₂ emitted after combustion in a vehicle engine may be calculated by using an engine model in some cases, where there is no (physical) CO₂ sensor in the vehicle. The engine model values may be inaccurate under special driving conditions such as the cooled engine state at the beginning of vehicle startup, the regenerating state of the exhaust gas post-processing system (diesel particulate filter (DPF)/selective catalytic reduction (SCR)), and rapid changes in fuel amount. This can cause inaccurate CO₂ emission calculations and large errors in engine work calculations using them.

### SUMMARY

The present disclosure describes a method and apparatus for controlling an engine of a vehicle capable of deriving a CO₂ emission amount and an engine work amount with improved accuracy and controlling an engine by utilizing a regression model corrected by reflecting vehicle characteristics without employing an additional CO₂ sensor in a vehicle.

The present disclosure further describes a method and apparatus for controlling an engine of a vehicle that calculates a more accurate CO₂ emission amount and engine work amount through a regression analysis corrected by comparing a CO₂ emission amount derived by utilizing a MAF sensor for an initial engine running time of a newly released vehicle with a regression model within the vehicle.

According to one aspect of the subject matter described in this application, a method for controlling an engine of a vehicle by a controller includes determining whether a running time of the engine exceeds a reference driving time, based on the running time being less than or equal to the reference driving time, determining a first CO2 emission amount corresponding to the driving time by utilizing a Mass Air Flow (MAF) sensor, determining a model CO2 amount based on a first regression model that has correlation data between a combusted fuel amount and a CO2 emission amount of the engine, comparing the first CO2 emission amount with the model CO2 amount, determining a correction factor to adjust the first regression model based on comparing the first CO2 emission amount with the model CO2 amount, applying the correction factor to the first regression model to thereby generate a second regression model, determining a second CO2 emission amount through the second regression model, and controlling the engine based on the second CO2 emission amount.

Implementations according to this aspect can include one or more of the following features. For example, determining the first CO2 emission amount can include obtaining an air amount measured by the MAF sensor and determining the first CO2 emission amount based on the air amount measured by the MAF sensor, an air/fuel ratio, an octane rating of fuel, a molecular weight of carbon monoxide, and a molecular weight of carbon dioxide.

In some implementations, determining the correction factor can include determining an error of the first regression model by comparing the first CO2 emission amount with the model CO2 amount determined through the first regression model, and determining the correction factor to correct the error to thereby generate the second regression model. In some examples, determining the correction factor can include generating correction factor data that correlate the correction factor with the combusted fuel amount and storing the correction factor data in a table format.

In some implementations, the method can further include, based on the engine running time exceeding the reference driving time, performing a regression analysis reflecting vehicle characteristics through the second regression model that is reconstructed by applying the correction factor stored in correction factor data corrected during the reference driving time, and determining the second CO2 emission amount through the regression analysis.

In some implementations, controlling the engine can include controlling a fuel injection timing or an ignition timing according to the second CO2 emission amount.

According to another aspect, an apparatus for controlling an engine of a vehicle includes a controller configured to control the engine by utilizing (i) an amount of carbon dioxide discharged from the engine and (ii) a model CO2 amount that is determined through a first regression model including a correlation between a combusted fuel amount and a carbon dioxide emission amount of the vehicle. The controller is configured to, during a reference driving time, determine a first CO2 emission amount according to a driving time by using a MAF sensor, determine a correction factor to adjust the first regression model based on comparing the first CO2 emission amount with the model CO2 amount determined through the first regression model, and after the reference driving time, determine a second CO2 emission amount through a second regression model that is generated by applying the correction factor to the first regression model.

Implementations according to this aspect can include one or more of the following features. For example, the controller can be configured to determine an engine work amount by utilizing the second CO2 emission amount. In some examples, the controller can be configured to control a fuel injection timing or an ignition timing according to the second CO2 emission amount.

In some examples, the apparatus can further include a driving information detector configured to detect driving information for calculation of an engine work amount. For example, the driving information can include a starting signal of the engine, and air and fuel amounts introduced into the engine.

In some implementations, an accurate CO₂ emission amount can be calculated according to driving of the vehicle by utilizing a customized regression model corrected by reflecting vehicle characteristics, without employing an CO₂ sensor, and an accurate engine work amount can be calculated by utilizing it.

In addition, through the accurate CO₂ emission amount reflecting the vehicle characteristic, the engine work amount can be accurately calculated even in special driving conditions such as an initially cooled engine state, a regenerating state of an exhaust gas post-processing system, and rapid changes of fuel amount.

In addition, the calculation of the accurate CO₂ emission amount, the engine work amount by using it, and MAW (moving average window) can be supported by considering the vehicle characteristics, so that European Union legislation changes and CO₂ reduction regulations in the near future can be proactively responded.

### BRIEF DESCRIPTION OF THE DRAWINGS

FIG. 1 schematically shows an example of an apparatus for controlling an engine of a vehicle.

FIG. 2 is a flowchart schematically showing an example of a method for controlling an engine of a vehicle.

FIG. 3 is a graph comparing example values used in an initial regression model 121a and measured values of actual fuel amount-CO₂ emission amount.

FIG. 4 is a graph showing example results of analysis verification utilizing a regression model corrected.

### DETAILED DESCRIPTION

The present disclosure will be described more fully hereinafter with reference to the accompanying drawings, in which example implementations of the disclosure are shown.

In the present disclosure, it is understood that one or more of the following methods or aspects thereof can be carried out by at least one controller. The term “controller” can refer to a hardware device including a memory and a processor. The memory is configured to store program instructions, and the processor is specifically programmed to execute the program instructions to perform one or more processes which are described further below. The controller can control operations of units, modules, components, devices, or the like, as described herein. In addition, it is understood that the following methods can be carried out by an apparatus including the controller as well as one or more other components, as recognized by those skilled in the art.

Hereinafter, an example of a method for controlling an engine of a vehicle will be described in detail with reference to the drawings.

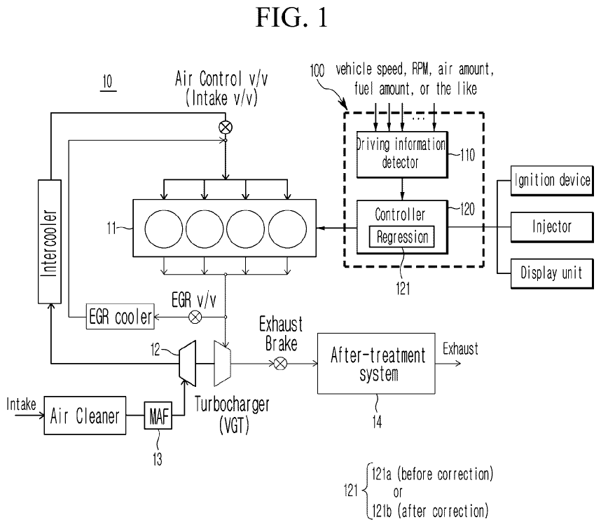

FIG. 1 schematically shows an example of an apparatus for controlling an engine of a vehicle.

Referring to FIG. 1, an apparatus 100 for controlling an engine of a vehicle of a vehicle can be applied to a vehicle 10 that is now equipped with a separate CO₂ sensor, and can include a driving information detector 110, and a controller 120 (e.g., an electronic control unit (ECU)).

The vehicle 10 can include an internal combustion engine 11 using a diesel or gasoline fuel, a forced induction device 12 (e.g., turbocharger, VGT, or the like) configured to supply a charged air into the engine 11, a Mass Air Flow (MAF) sensor 13 configured to measure an intake air amount of the engine 11, a post-processing system 14 configured to purify an exhaust gas of the engine 11. In addition, the vehicle 10 can be provided with an intake valve configured to adjust the intake air introduced into the engine 11, an exhaust valve configured to adjust the exhaust gas discharged from the engine 11, an intercooler configured to cool the intake air, and an EGR cooler configured to cool the exhaust gas.

The engine 11 generates power for driving of the vehicle 10 through combustion of fuel.

The driving information detector 110 can detect the driving information detected through various sensors after the engine of the vehicle 10 is started and transmit the detected information to the controller 120. The driving information detector 110 can serve as an interface for transmitting/receiving information for the engine control of the controller 120. For example, the driving information detector 110 can detect the driving information for calculation of an engine work amount, such as a starting signal of the engine, the air amount and fuel amount introduced into the engine, or the like. In addition, the driving information can further include a vehicle speed, a throttle valve opening, an engine RPM, an intake manifold pressure, a coolant temperature, an exhaust gas air/fuel ratio, or the like, which are typically measured and/or calculated for controlling the engine.

The controller 120 can control an overall operation of the engine 11 based on the driving information collected from the driving information detector 110.

In order to proactively respond to global exhaust gas regulations and/or European Union law changes, the controller 120 can calculate the improved engine work amount, and can include at least one processor, program, and data for such.

During driving of the vehicle, the controller 120 can accurately calculate a carbon dioxide (CO₂) emission amount discharged from the engine 11 based on the driving information collected from the driving information detector 110, and can accurately calculate the engine work amount by using this.

The controller 120 can be equipped with a regression model 121 in order to calculate the CO₂ emission amount without employing a separate sensor within the vehicle. The regression model 121 can be established based on data set in advance through engine experiment and commonly equipped in the mass-produced/newly released vehicle, and hereinafter, can be referred to as an “initial regression model 121a”, for better understanding and ease of description.

The controller 120 can calculate the CO₂ emission amount (i.e., a model CO₂ amount) discharged from the engine 11 through the regression model 121 utilizing correlation between a combusted fuel amount and carbon dioxide (CO₂) when a vehicle that is not equipped with the CO₂ sensor is started up, and can calculate the engine work amount by utilizing the calculated CO₂ emission amount.

In some examples, when the CO₂ emission amount is calculated by utilizing the initial regression model 121a equipped in mass-produced vehicles, an error of the CO₂ emission amount can occur due to vehicle characteristics of individual vehicles in special driving conditions such as an initially cooled engine state, a regenerating state of an exhaust gas post-processing system, and rapid changes of fuel amount.

In some implementations, in order to reflect the vehicle characteristics (including tolerance of each component of mass-produced individual vehicles) of each vehicle, the controller 120 can correct the initial regression model 121a utilized for calculating the CO₂ emission amount by analyzing the combusted fuel amount of the engine 11 using the Mass Air Flow (MAF) sensor 13. Therefore, the controller 120 can reconstruct the initial regression model 121a as a customized regression model 121b corrected according to the corresponding vehicle characteristics.

In more detail, the controller 120 can calculate the CO₂ emission amount (hereinafter, also referred to as an “actual CO₂ emission amount”) reflecting the vehicle characteristics by analyzing the combusted fuel amount of the engine 11 by using a MAF sensor 13 for a certain driving time after the vehicle has been released as a new vehicle, and correct the error by comparing the actual CO₂ emission amount with the initial regression model 121a and store a correction factor (k) derived according to the error correction. In addition, the controller 120 can calculate the CO₂ emission amount having an improved accuracy through the analysis of the customized regression model 121b reflecting the vehicle characteristic by using the correction factor (k) after the certain driving time.

Therefore, the controller 120 can calculate the accurate engine work amount by utilizing the CO₂ emission amount that is improved in accuracy. That is, the controller 120 can calculate the engine work amount in which the error due to vehicle characteristics is corrected by utilizing the corrected CO₂ emission amount.

In some cases, European Union law changes in the near future can be proactively responded by supporting accurate calculation of the CO₂ emission amount and the engine work amount.

In some examples, the controller 120 can be implemented as one or more processors operated by a predetermined program, and the predetermined program can be one programmed to perform respective steps of a method for controlling an engine of a vehicle.

Hereinafter, a method for controlling an engine of a vehicle will be described in more detail with reference to the drawings.

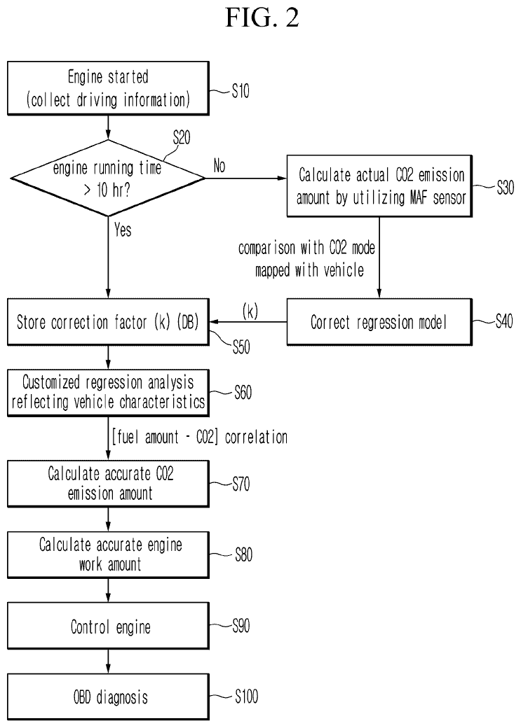

FIG. 2 is a flowchart schematically showing an example of a method for controlling an engine of a vehicle.

Referring to FIG. 2, in some implementations, a method for controlling an engine of a vehicle is to determine the engine work amount by using the CO₂ emission amount, and will be described under a scenario in which the CO₂ emission amount is tracked through a regression analysis of a vehicle that is not equipped with a CO₂ sensor.

The controller 120 of the apparatus 100 for calculating the engine work amount can collect the driving information of the vehicle when the engine is started (turned on), at step S10. The driving information can include an engine running time detected according to driving of the vehicle, the air amount and fuel amount supplied into the engine, or the like.

A vehicle assembled in the factory can have vehicle characteristics including various errors, such as an injector fuel injection error of the engine, an error in opening of the intake valve and the exhaust valve, an error of the air intake amount of a turbocharger, or the like, and deviations of components, for individual vehicles. Therefore, in order to calculate the CO₂ emission amount and the engine work amount in which the error for each vehicle is corrected, a correction of a regression model can reflect vehicle characteristics of each vehicle.

For example, the controller 120 can determine whether an engine running time after the vehicle has been released as a new vehicle exceeds a predetermined reference driving time (e.g., 10 hr) based on the collected driving information, at step S20.

At this time, when the engine running time is less than or equal to the predetermined reference driving time (e.g., 10 hr) (S20; No), the controller 120 can calculate the CO₂ emission amount according to the driving time by utilizing the MAF sensor 13 in order to consider the vehicle characteristics, at step S30. Here, the actual CO₂ emission amount can be measured through the combusted fuel amount analysis utilizing the MAF sensor 13, in which the vehicle characteristics of that vehicle is included.

The controller 120 can calculate the actual CO₂ emission amount according to the driving time through an air/fuel ratio (AFR) utilizing the air amount (MAF) measured by the MAF sensor 13, the octane rating (or, cetane rating of the fuel) of the fuel, the molecular weight of carbon dioxide, and the molecular weight of carbon.

For determining the CO₂ emission amount, the octane rating can be applied for the gasoline engine, and the cetane rating can be applied for the diesel engine. Hereinafter, the gasoline engine will be taken as an example in the following description.

The air amount (MAF) measured by the MAF sensor 13 can be the amount of air mixed with each 1 g of fuel during the combustion process of the engine, and the air/fuel ratio can be controlled to be constant. For example, the theoretical air/fuel ratio of a gasoline engine can be 14.7, and the theoretical air/fuel ratio of a diesel engine can be 16 to 18.

Therefore, through the equation below, the controller 120 can determine a fuel flow rate.

$$dF [ g / s ] = MAF / 14.7 \qquad ( Equation 1 )$$

The controller 120 can calculate a total fuel flow rate (Fₛᵤₘ) supplied to the engine by using the air amount measured by the MAF sensor 13 and the theoretical air/fuel ratio, and can calculate the total fuel flow rate (Fₛᵤₘ) used during the running time of the engine (i.e., the driving time of the vehicle). The total fuel flow rate (Fₛᵤₘ) can be calculated by using Equation 2 below.

$${dF}_{sum} = {\sum }_{i = 0}^{N} {dF}_{i} \times Δ t \qquad ( Equation 2 )$$

(here, Δt is the engine running time)

The controller 120 can convert the total fuel flow rate (Fₛᵤₘ) into CO₂ mass (g) by using the chemical reaction formula of octane (C₈H₁₈).

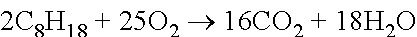

The weight ratio (P) of carbon (C) in octane can be calculated by using Equation 3 below.

$$P = 8 C / ( 8 C + 18 H ) = 0.84117 \qquad ( Equation 3 )$$

Here, C means the molecular weight of carbon (12.0107 g/mol), H means the molecular weight of hydrogen (1.00794 g/mol), and O means the molecular weight of oxygen (15.9994 g/mol).

In the same way, the emission flow rate (M) of CO₂ can be calculated by using the chemical reaction formula of Equation 2, and can be calculated by Equation 4 below using the molecular weight of carbon dioxide and carbon.

$$M [ g / s ] = dF \times P \times \frac{{M}_{co 2}}{{M}_{c}} = MAF \times 0.20967 \qquad ( Equation 4 )$$

Here, M_{CO2} means the molecular weight of carbon dioxide (44.0095 g/mol), M_{C} means the molecular weight of carbon (12.0107 g/mol), dF means the fuel flow rate, and MAF means the air amount supplied to the engine.

Therefore, the total CO₂ emission flow rate (E_{CO2}) according to the engine running time can be calculated by using Equation 5 below by using the chemical reaction formula of cetane (or, octane).

$${E}_{CO 2} = {\sum }_{i = 0}^{N} {dM}_{i} \times Δ t \qquad ( Equation 5 )$$

Here,

At this time, since the unit of the CO₂ emission flow rate (M) is [g/s], a total CO₂ emission amount can be derived by multiplying it by the engine running time Δt.

The controller 120 can record the CO₂ emission amount according to the engine running time every predetermined time (e.g., 1 second) unit, and the recorded data can be used for comparatively analyzing data of the initial regression model 121a set in the vehicle.

The controller 120 can correct the error of the initial regression model 121a in consideration of the vehicle characteristics, by comparing the previously calculated actual CO₂ emission amount with the initial regression model 121a set in the vehicle, at step S40.

The controller 120 can correct the error (the CO₂ emission amount) of the initial regression model 121a by comparing the actual CO₂ emission amount calculated by utilizing the value of the MAF sensor 13 for the reference driving time (e.g., 10 hours) with the CO₂ emission amount determined by the initial regression CO₂ model mapped in the vehicle (e.g., data mapped in an engine experiment). In addition, the controller 120 can determine the correction factor (k) for determining the customized regression model appropriate for the vehicle characteristics according to the error correction of the initial regression model.

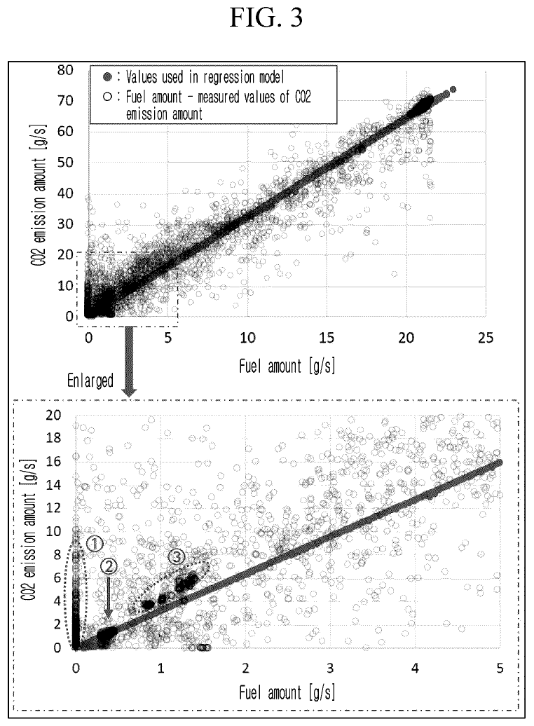

For example, FIG. 3 is a graph comparing values used in the initial regression model 121a (hereinafter, referred to as “model value”) and measured values of actual fuel amount—CO₂ emission amount (hereinafter, referred to as “measured value”).

Referring to FIG. 3, as shown in the graph, the trends of values (indicated as points on the diagonal line) used in the initial regression model and the fuel amount-measured values (indicated as open circles) of the CO₂ emission amount utilizing the value of the MAF sensor 13 can be similar to each other, and some measurement error can be absorbed in the regression model.

Hereinafter, the description will be made with reference to the enlarged graph shown in the bottom of FIG. 3.

In the section \textcircled{1}, since there is no CO₂ emission amount theoretically when the fuel amount 0 g/, the measured value by the MAF sensor 13 can correspond to the measurement error. At this time, when the CO₂ emission amount is determined according to the initial regression model 121a, the accurate CO₂ emission amount can be obtained. That is, since this corresponds to the coasting driving region of the vehicle and there is not CO₂ emission, the correction value is determined as 0, and the measured value by the MAF sensor 13 can be the same as the initial regression model.

In the section \textcircled{2}, since the CO₂ emission amount determined by the MAF sensor 13 and the CO₂ emission amount determined by the initial regression model 121a are the same, the value of the initial regression model can be used, and the correction value can be determined as 1.

In the section \textcircled{3}, since the measured value by the MAF sensor 13 (the actual CO₂ emission amount) is slightly larger than that of the initial regression model 121a, the correction value of fuel amount of between 0.8 to 1.5 [g/s] can be determined to be 1.1 to 1.4. To the contrary, when the measured value by the MAF sensor 13 (the actual CO₂ emission amount) is smaller than the initial regression model 121a, the correction value can be determined as a negative number.

The controller 120 can form and store database (DB) with the correction factor (k) derived according to the error correction of the initial regression model 121a, as shown in the table below, at step S50.

TABLE 1
Correction factor data

| | | | | | | |
|---|---|---|---|---|---|---|
| Fuel amount [g/s] | 0 | 1 | 2 | 5 | 10 | 15 |
| Factor | | | | | | |

As shown in <Table 1>, the controller 120 can derive the correction factor (k) corresponding to the combusted fuel amount, to generate correction factor data stored in a table format. In addition, the controller 120 can correct the initial regression model 121a through the stored correction factor data (DB), so as to improve accuracy of the CO₂ emission amount calculation.

The controller 120 can perform a regression analysis by utilizing the customized regression model 121b corrected by applying the correction factor (K), at step S60, and can calculate the CO₂ emission amount having an improved accuracy by reflecting the vehicle characteristics through this, at step S70. In addition, the controller 120 can calculate the accurate engine work amount and the moving average window (MAW), by utilizing the CO₂ emission amount that is improved in accuracy, at step S80.

In some examples, at the step S20, when the engine running time exceeds the predetermined reference driving time (e.g., 10 hr) (S20; Yes), the correction factor data (DB) stored for the reference driving time can be utilized for a customized regression analysis.

The controller 120 can perform a regression analysis reflecting vehicle characteristics through the customized regression model 121b reconstructed by applying correction factor (K) stored in the correction factor data (DB), at step S60, and can determine the CO₂ emission amount having an improved accuracy through this, at the step S70.

In addition, the controller 120 can calculate the accurate engine work amount and the moving average window (MAW), by utilizing the CO₂ emission amount that is improved in accuracy, at the step S80.

Here, the calculation of the engine work amount can be calculated according to what is specified in the European commercial vehicle real driving emission (RDE) law (595/2009, revised 2018/1832). For example, by deriving the CO₂ emission amount, the combusted fuel amount can be obtained, and when the combusted fuel amount, the rpm, and engine torque of the vehicle engine is obtained through the driving information, the engine work amount can be calculated by utilizing the engine curve graph (rpm/output/torque curve).

Alternatively, the controller 120 can determine a fuel consumption amount through the relationship of the amount carbon dioxide discharged when a predetermined amount of fuel (e.g., diesel fuel) is combusted, the total energy generated at the engine can be determined through the fuel consumption amount, and the engine work amount can be determined through the total energy generated at the engine.

For example, since about 3.15 kg of carbon dioxide is emitted when 1 kg of diesel is combusted, the fuel consumption amount can be determined through Equation 6 below.

$$Fuel consumption amount = {CO}_{2} emission amount / 3.15 \qquad [ Equation 6 ]$$

In addition, since the energy of 1 kg of diesel is 42.6 MJ, the total energy generated at the engine can be determined through Equation 7 below.

$$Total energy = Fuel consumption amount * 42.6 \qquad [ Equation 7 ]$$

Therefore, the engine work amount can be determined as a multiplication of the total energy generated at the engine and the engine efficiency (see Equation 8).

$$Engine work amount = Total energy * Engine efficiency \qquad [ Equation 8 ]$$

Here, engine efficiency can be about 40-45%, which can be determined to be different depending on the engine.

As such, the controller 120 can calculate the CO₂ emission amount having an improved accuracy through the customized regression model corrected by reflecting characteristics of mass-produced vehicles, and by calculating the engine work amount and moving average window (MAW) utilizing the same, the error can be reduced relative to a method for calculating the engine work amount and MAW by using the engine torque.

The controller 120 can control the engine by utilizing the CO₂ emission amount that is improved in accuracy, at step S90.

The controller 120 can determine the fuel consumption amount based on the CO₂ emission amount discharged from the engine, and can calculate the fuel consumption amount or a fuel efficiency according to the travel distance of the vehicle. In addition, the controller 120 can control the engine based on the fuel consumption amount or the fuel efficiency.

For example, the controller 120 can adjust the injection timing of fuel so that the engine can operate in an operation region (e.g., an operation region of the engine having highest CO₂ emission amount) of engine (e.g., in the case of a diesel engine) having the lowest fuel consumption amount.

Alternatively, the controller 120 can adjust the ignition timing of the ignition device so that the engine can operate in an operation region (e.g., an operation region of the engine having highest CO₂ emission amount) of engine (e.g., in the case of a gasoline engine) having the lowest fuel consumption amount.

In some examples, when the fuel is completely combusted in the engine, the carbon dioxide emission amount can increase, and the emission amount of noxious gases such as carbon monoxide and hydrocarbon can increase. Therefore, in some cases, the engine can operate in a driving region where the carbon dioxide emission amount is maximal, and the controller 120 can adjust the injection timing of fuel or the ignition timing of the ignition device so that a carbon monoxide emission amount becomes largest.

The controller 120 can execute on-board diagnostics (OBD) diagnose by utilizing the CO₂ emission amount that is improved in accuracy, at step S100.

For example, when the CO₂ emission amount having an improved accuracy exceeds a reference emission amount, the controller 120 can determine that the combustion of the engine is incomplete, or there is an abnormality in the ignition device. In some cases, the controller 120 can provide an alarm for notifying a vehicle maintenance to the driver through a display (e.g., a center fascia equipped in the vehicle, or the like).

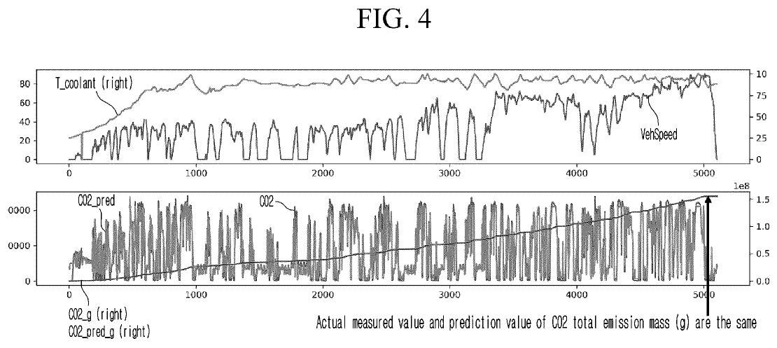

In some examples, FIG. 4 is a graph showing example results of analysis verification utilizing a regression model corrected.

Referring to FIG. 4, CO₂ values were measured by using a portable emissions measurement systems (PEMS) equipment according to the vehicle speed VehSpeed. The CO₂_pred values show results obtained by analyzing the CO₂ emission amount according to the vehicle speed by utilizing a regression model corrected by reflecting vehicle characteristics. Here, it can be seen that the CO₂ total emission masses, CO₂_g and CO₂_pred_g, coincide with each other for the total driving time of the vehicle.

As such, an accurate CO₂ emission amount can be calculated according to driving of the vehicle by utilizing a customized regression model corrected by reflecting vehicle characteristics, without employing an CO₂ sensor, and the accurate engine work amount can be calculated by utilizing it.

In addition, through the accurate CO₂ emission amount reflecting the vehicle characteristic, the engine work amount can be accurately calculated even in special driving conditions such as an initially cooled engine state, a regenerating state of an exhaust gas post-processing system, and rapid changes of fuel amount.

In addition, the calculation of the accurate CO₂ emission amount, the engine work amount by using it, and MAW can be supported by considering the vehicle characteristics, so that European Union legislation changes and CO₂ reduction regulations in the near future can be proactively responded.

In addition, by control the engine by utilizing the carbon dioxide emission amount, the fuel efficiency of the vehicle can be improved.

In addition, by performing the OBD diagnosis by utilizing the carbon dioxide emission amount, the status of the engine can be diagnosed, and information on abnormalities of the vehicle can be provided to the driver.

The example implementations of the present disclosure described above are not only implemented by the apparatus and the method, but can be implemented by a program for realizing functions corresponding to the configuration of the implementations of the present disclosure or a recording medium on which the program is recorded.

While this disclosure has been described in connection with what is presently considered to be practical example implementations, it is to be understood that the disclosure is not limited to the disclosed implementations, but, on the contrary, is intended to cover various modifications and equivalent arrangements included within the spirit and scope of the appended claims.

What is claimed is:

1. A method for controlling an engine of a vehicle by a controller, the method comprising:
determining whether a running time of the engine exceeds a reference driving time;
based on the running time being less than or equal to the reference driving time, determining a first CO₂ emission amount corresponding to the driving time by utilizing a Mass Air Flow (MAF) sensor;
determining a model CO₂ amount based on a first regression model that has correlation data between a combusted fuel amount and a CO₂ emission amount of the engine;
comparing the first CO₂ emission amount with the model CO₂ amount;
determining a correction factor to adjust the first regression model based on comparing the first CO₂ emission amount with the model CO₂ amount;
applying the correction factor to the first regression model to thereby generate a second regression model;
determining a second CO₂ emission amount through the second regression model; and
controlling the engine based on the second CO₂ emission amount.

2. The method of claim 1, wherein determining the first CO₂ emission amount comprises:
obtaining an air amount measured by the MAF sensor; and
determining the first CO₂ emission amount based on the air amount measured by the MAF sensor, an air/fuel ratio, an octane rating of fuel, a molecular weight of carbon monoxide, and a molecular weight of carbon dioxide.

3. The method of claim 1, wherein determining the correction factor comprises:
determining an error of the first regression model by comparing the first CO₂ emission amount with the model CO₂ amount determined through the first regression model; and
determining the correction factor to correct the error to thereby generate the second regression model.

4. The method of claim 3, wherein determining the correction factor comprises:
generating correction factor data that correlate the correction factor with the combusted fuel amount; and
storing the correction factor data in a table format.

5. The method of claim 1, further comprising:
based on the engine running time exceeding the reference driving time, performing a regression analysis reflecting vehicle characteristics through the second regression model that is reconstructed by applying the correction factor stored in correction factor data corrected during the reference driving time; and
determining the second CO₂ emission amount through the regression analysis.

6. The method of claim 1, wherein controlling the engine comprises:
controlling a fuel injection timing or an ignition timing according to the second CO₂ emission amount.

7. An apparatus for controlling an engine of a vehicle, comprising:
a controller configured to control the engine by utilizing (i) an amount of carbon dioxide discharged from the engine and (ii) a model CO₂ amount that is determined through a first regression model including a correlation between a combusted fuel amount and a carbon dioxide emission amount of the vehicle,
wherein the controller is configured to:
during a reference driving time, determine a first CO₂ emission amount according to a driving time by using a MAF sensor,
determine a correction factor to adjust the first regression model based on comparing the first CO₂ emission amount with the model CO₂ amount determined through the first regression model, and
after the reference driving time, determine a second CO₂ emission amount through a second regression model that is generated by applying the correction factor to the first regression model.

8. The apparatus of claim 7, wherein the controller is configured to determine an engine work amount by utilizing the second CO₂ emission amount.

9. The apparatus of claim 7, wherein the controller is configured to control a fuel injection timing or an ignition timing according to the second CO₂ emission amount.

10. The apparatus of claim 7, further comprising a driving information detector configured to detect driving information for calculation of an engine work amount.

11. The apparatus of claim 10, wherein the driving information includes a starting signal of the engine, and air and fuel amounts introduced into the engine.
